(19) United States
(12) Patent Application Publication
(10) Pub. No.: US 2018/0194028 A1
(43) Pub. Date: Jul. 12, 2018

(54) ELASTICALLY CONVERTING FLEXIBLE STAINLESS STEEL CIGS SHEETS

(71) Applicants: Stephen Motta, Santa Clara, CA (US); Andrew Nordhoff, Santa Clara, CA (US); Kedar Y. Hardikar, Santa Clara, CA (US); Heinrich von Bunau, San Jose, CA (US); Robert Martinson, Palo Alto, CA (US)

(72) Inventors: Stephen Motta, Santa Clara, CA (US); Andrew Nordhoff, Santa Clara, CA (US); Kedar Y. Hardikar, Santa Clara, CA (US); Heinrich von Bunau, San Jose, CA (US); Robert Martinson, Palo Alto, CA (US)

(21) Appl. No.: 15/400,135

(22) Filed: Jan. 6, 2017

(51) Int. Cl. B26D 1/22; B26D 1/00; B26D 7/01; B65H 35/02

(52) U.S. Cl. CPC B26D 1/225; B26D 1/0006; B65H 2301/5155; B65H 35/02; B26D 2001/0053; B26D 7/015

(57) ABSTRACT

Disclosed are apparatuses and methods for cutting thin film solar cells. The apparatus may include circular knife cutter rollers, each having a knife edge and coupled with a cutter arbor, support rollers, each coupled to a support arbor and having first and second outer surfaces and a circumferential gap between the first and second outer surfaces partially defined by a first side, a second side facing and offset from the first side, a first rounded edge where the first side intersects with the first outer surface, and a second sharp edge where the second side intersects with the second outer surface. The cutter arbor and support arbor are offset, and the knife cutter rollers and support rollers are axially spaced, such that one knife edge is positioned in the gap of each support roller and the web may be fed between the cutter arbor and the support arbor.

### BACKGROUND

Photovoltaic (PV) cells are widely used in for generation of electricity. Multiple PV cells may be interconnected in a module assembly. Such modules may be integrated into building structures or otherwise assembled to convert solar energy into electricity by the PV effect.

Certain PV cell fabrication processes involve depositing thin film materials on a substrate to form a light absorbing layer sandwiched between electrical contact layers. The front or top contact is a transparent and conductive layer for current collection and light enhancement, the light absorbing layer is a semiconductor material, and the back contact is a conductive layer to provide electrical current throughout the cell.

In one example of a fabrication process, a metallic back electrical contact layer is deposited on a substrate. A p-type semiconductor layer is then deposited on the back contact electrical contact layer and an n-type semiconductor layer is deposited on the p-type semiconductor layer to complete a p-n junction. Any suitable semiconductor materials, such as CIGS, CIS, CdTe, CdS, ZnS, ZnO, amorphous silicon, polycrystalline silicon, etc. may be used for these layers. A top transparent electrode layer is then deposited on the p-n junction. This layer may be a conductive oxide or other conductive film and is used for current collection. Once these or other materials have been deposited on the substrate to form a PV stack, the substrate and thin film materials deposited on it are cut into cell-sized units.

### SUMMARY

In one embodiment, an apparatus for cutting a web with a first face, a second face opposite the first face and offset from the first face by a nominal thickness may be provided. The apparatus may include a plurality of substantially circular knife cutter rollers, each knife cutter roller having a substantially circular knife edge that is the outer-most circumferential boundary of the knife cutter roller; a cutter arbor, with each knife cutter roller coupled with the cutter arbor such that the knife edges are coaxial with each other; a plurality of support rollers, each support roller having a substantially cylindrical first outer surface, a substantially cylindrical second outer surface coaxial with the first outer surface, and a circumferential gap between the first outer surface and the second outer surface, and each gap may be partially defined by a first side, a second side that faces and is offset from the first side, a first edge where the first side intersects with the first outer surface, and a second edge where the second side intersects with the second outer surface, the first edge may be rounded with a first radius, and the second edge may be sharp or may have a second radius that is substantially smaller than the first radius; and a support arbor, with each support roller coupled with the support arbor such that the support rollers are coaxial with each other. The cutter arbor may be offset from the support arbor, and the knife cutter rollers and the support rollers may be axially spaced, such that one knife edge is positioned in the gap of each support roller and the web may be fed between the cutter arbor and the support arbor.

In some embodiments, the second edge may be sharp.

In some embodiments, the second edge may be rounded with a second radius that is substantially smaller than the first radius.

In some embodiments, the knife edge may be sharp.

In some embodiments, the knife edge may be rounded with a third radius that is substantially smaller than the first radius.

In some embodiments, the knife edge may be formed by the intersection of a first knife surface and a second knife surface and the internal angle between the first knife surface and the second knife surface may be less than 180 degrees.

In some such embodiments, only the knife edge, at least a part of first knife surface, and at least a part of the second knife surface of each knife cutter roller may be positioned in the gap.

In some further such embodiments, neither the first knife surface nor the second knife surface may be parallel to the support surfaces.

In some other such embodiments, the knife edge may be a type of edge selected from the group consisting of: V ground, convex, asymmetrical semi-convex, asymmetrical V, compound bevel, hollow ground, chisel, chisel back bevel, and chisel urasuki.

In some embodiments, the first edge may not be rounded and may be of a geometry that includes one or more of: facets, chamfers, ellipses, and paraboloids.

In some embodiments, each knife edge may be axially separated from each corresponding second face by a first separation distance and is positioned within the gap by a penetration distance such that it is closer to a rotational axis of the support arbor in a direction perpendicular to the rotational axis than the second outer surface of the support roller is to the rotational axis.

In some embodiments, the apparatus may be configured to cause a burst fracture of the web in each gap.

In some such embodiments, the apparatus may be further configured to cause a first portion of the web closer to the first edge to elastically deform and a second portion of the web closer to the second edge to plastically deform.

In some other such embodiments, the apparatus may be configured not to cause shearing of the web.

In some other such embodiments, the apparatus may be further configured to separate the web into a plurality of strips, each strip may have a first strip face, a second strip face opposite the first strip face, a left side with a first down-burr, and a second side with a second down-burr, the first down-burr may be angled away from the second strip face by a first angle, and the second down-burr may be angled away from the second strip face by a second angle greater than the first angle.

In some further such embodiments, the first angle may be between about 90 degrees and about 150 degrees and the second angle may be between about 160 degrees and about 180 degrees.

In some embodiments, the apparatus may be configured to cause a web that is fed between the cutter arbor and the support arbor to have the first face in contact with each knife edge and the second face in contact with each first outer surface, second outer surface, and second edge.

In some embodiments, the only part of the cutter arbor that may be in contact with the first face of the web is the knife edge of each cutter roller.

In some embodiments, the apparatus may be further configured to hold the web in tension by causing at least two neighboring knife edges to contact the first face of the web and simultaneously causing the second edge that is axially between the two neighboring knife edges to contact the second face of the web.

In one embodiment, an apparatus for cutting a web with a first face, a second face opposite the first face and offset from the first face by a nominal thickness may be provided. The apparatus may include a plurality of substantially circular knife cutter rollers, each knife cutter roller having a substantially circular knife edge that is the outer-most circumferential boundary of the knife cutter roller; a cutter arbor, with each knife cutter roller coupled with the cutter arbor such that the knife edges are coaxial with each other; a plurality of support rollers, each support roller having a substantially cylindrical first outer surface, a substantially cylindrical second outer surface coaxial with the first outer surface, and a circumferential gap between the first outer surface and the second outer surface, and each gap may be partially defined by a first side, a second side that faces and is offset from the first side, a first edge where the first side intersects with the first outer surface, and a second edge where the second side intersects with the second outer surface, the first edge may be of a geometry that may include two or more facets, a chamfer, or a combination of two or more facets, a chamfer, and one or more curved surfaces, and the second edge may be sharp or may have a second radius that is substantially smaller than the vertical depth of the first edge in a direction perpendicular to a rotational axis of a support arbor; and a support arbor, with each support roller coupled with the support arbor such that the support rollers are coaxial with each other. The cutter arbor may be offset from the support arbor, and the knife cutter rollers and the support rollers may be axially spaced, such that one knife edge is positioned in the gap of each support roller and the web may be fed between the cutter arbor and the support arbor.

In some embodiments, the second edge may be sharp.

### BRIEF DESCRIPTION OF THE DRAWINGS

FIG. 1 depicts a perspective view of a conceptual PV layered stack as both an uncut layered stack and as a series of cut PV cell strips.

FIG. 2 depicts an example PV stack and example cross-sections of PV cell strips that have a dual down-burr.

FIG. 3 depicts a cross-sectional view of example PV cell strips with two different down-burrs.

FIG. 4 depicts an isometric view of a PV stack and the PC cell strips of FIG. 3.

FIG. 5 depicts a side view of an example cutting apparatus that may be used to cut a substrate/thin film stack into multiple cell-width sized strips as depicted schematically in FIG. 1.

FIG. 6 depicts a sectional front view of an example cutter mechanism that includes a cutting cylinder and a support cylinder.

FIG. 7 depicts the example cutter mechanism of FIG. 6 with spacer rollers of the cutting cylinder removed such that the plurality of knife cutter rollers of the cutting cylinder can be seen.

FIG. 8 depicts a cross-sectional view of an example knife edge of an example knife cutter.

FIG. 9 depicts various example knife edges.

FIG. 10 depicts a cross-sectional view of an example support roller.

FIG. 11 depicts a detail view of a section of the support roller of FIG. 10.

FIG. 12 depicts a detail view of portions of one support roller and one cutter roller of FIG. 6.

FIG. 13 depicts a detail view of parts of the knife cutter roller and support roller of FIG. 12.

FIG. 14 depicts the detail view of FIG. 12 along with an example web.

FIG. 15 depicts another detail view of parts of the cutter cylinder and the support cylinder of FIG. 6, as well as the example web.

FIG. 16 depicts one example technique for cutting a PV stack web.

FIG. 17 depicts four example first edges of the support rollers.

FIG. 18 depicts a first edge of FIG. 17 that has facets.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific implementations, it will be understood that these implementations are not intended to be limiting.

There are many concepts and implementations described and illustrated herein. While certain features, attributes and advantages of the implementations discussed herein have been described and illustrated, it should be understood that many others, as well as different and/or similar implementations, features, attributes and advantages of the present inventions, are apparent from the description and illustrations. As such, the below implementations are merely some possible examples of the present disclosure. They are not intended to be exhaustive or to limit the disclosure to the precise forms, techniques, materials and/or configurations disclosed. Many modifications and variations are possible in light of this disclosure. It is to be understood that other implementations may be utilized and operational changes may be made without departing from the scope of the present disclosure. As such, the scope of the disclosure is not limited solely to the description below because the description of the above implementations has been presented for the purposes of illustration and description.

Importantly, the present disclosure is neither limited to any single aspect nor implementation, nor to any single combination and/or permutation of such aspects and/or implementations. Moreover, each of the aspects of the present disclosure, and/or implementations thereof, may be employed alone or in combination with one or more of the other aspects and/or implementations thereof. For the sake of brevity, many of those permutations and combinations will not be discussed and/or illustrated separately herein.

Various terms as used herein are first defined as follows.

Neighboring: In the context of rollers sharing a common axis, the neighboring rollers of a given roller are one or both rollers closest to the given roller and coaxial with the given roller. In the context of rollers located on two non-coaxial axes, the neighboring rollers for a given roller are the rollers which would be closest to the given roller if the axes were instead coaxial.

Edge: An edge, in the context of rollers, may refer to a sharp or rounded edge. In the case of a sharp edge, the edge refers to the region where two surfaces, e.g., a cylindrical surface and a side, intersect. In the case of a rounded edge, the intersecting surfaces may, in reality, not actually intersect since the round acts to terminate the surfaces before they contact each other. However, such rounded geometries are still referred to herein as “edges” despite the lack of an actual surface intersection. Edges, in the context of a PV cell, may refer to the sides of the cell which define the overall, two-dimensional shape of the PV cell. For example, a rectangular PV cell would generally be defined by four edges. A sharp edge, as used herein, refers to an edge that does not have any rounding or radius, and the sharp edge may be created by two surfaces that intersect and have an internal angle less than 180 degrees, such as 90 degrees. It is to be understood, however, that some rounding of a sharp edge may be introduced which is not intended to be present, for example, over time, a sharp edge may be rounded by wear and tear from repeated cutting operations.

Sides: In the context of rollers, sides refer to reference surfaces which bound either end of a substantially cylindrical contact surface, i.e., a side is a substantially planar reference surface which is orthogonal to the central axis of the substantially cylindrical contact surface and which intersects or would intersect with a roller contact surface or an extension of the roller contact surface. The sides of a roller may include features which do not correspond with the side, such as grooves, ridges, holes, pins, etc. The ends of a roller may also not be truly planar, e.g., the ends of a roller may feature a slight taper or curved profile. These features should not be viewed as incompatible with the “sides” as described above.

Substantially cylindrical: In the context of the contact surfaces of the rollers, “substantially cylindrical” means that the contact surfaces are nominally cylindrical in shape. Such surfaces may, for example, be ridged, grooved, textured, etc. while still being “substantially cylindrical.” Substantially cylindrical surfaces may also include slight tapers or other relief features, such as step-downs in diameter.

Edge round/radius: An edge where two surfaces meet, or where two surfaces would intersect if extended until intersection occurs, may be sharp or may be smoothed in some manner. One common smoothing technique is to round the edge with a constant radius. Other smooth profiles may be used, such as non-circular curves, although typically such smoothing still involves a smoothing profile which is tangent to one or both of the surfaces forming the edge. In this application, reference to an edge as “rounded” or with a “radius” should be interpreted as encompassing non-circular or variable-radius blends between two surfaces and partial-round features as well as standard constant-radius rounds.

Local orientation: The orientation of a portion of a larger part with respect to the general orientation of the larger part. For example, a strip of material which is bent at a 30° angle at one end with respect to the general orientation of the entire strip of material would have a local orientation in the bent portion which was at a 30° angle.

Web: The term “web,” as used herein, refers to a large, thin sheet. The web may, for example, be a relatively discrete sheet of material, such as a 1 m by 2 m sheet, or may be relatively continuous, such as a sheet fed from a roll of material. The web may also be a laminate material and may have a thickness of about 50 micrometers stainless steel (SST). PV stacks, as described herein, may be implemented as a web or on a web of material.

As indicated above, certain PV cell fabrication processes involve depositing thin film materials on a substrate. These materials may form, for example, a back contact, an absorber material and a top contact layer as well as other possible layers of a PV stack. Once these materials have been deposited on the substrate to form a PV stack, the substrate and thin film materials deposited on it are cut into cell-sized units.

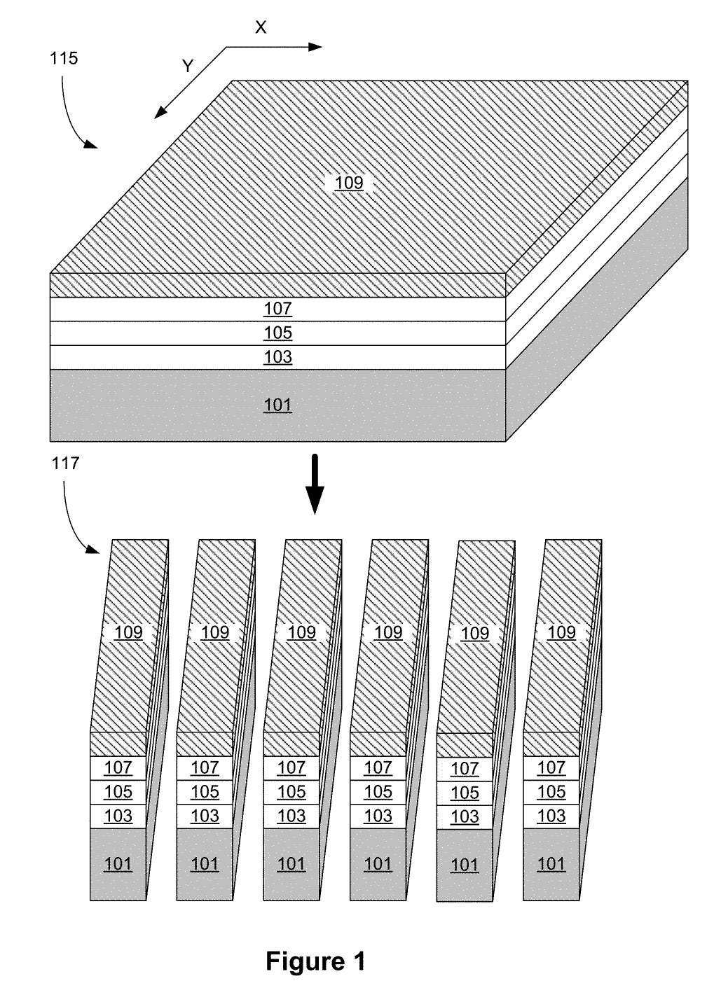

The present invention relates to cutting substrates having thin film solar cell materials deposited thereon. FIG. 1 depicts a perspective view of a conceptual PV layered stack as both an uncut layered stack and as a series of cut PV cell strips. As used herein, the PV layered stack may be referred to as the “PV web,” “PV web stack,” “web,” and/or “PV stack.” For the purposes of illustration, the figure is not to scale; for example, thickness of the substrate may be on the order of mils, the thickness of the thin film stack of PV material on the order of microns (or hundredths of mils), such as about 2 micrometers, with the x- and y-dimensions of the substrate on the order of feet. In certain implementations, substrate 101, i.e., a web, is a metallic substrate, e.g., a thin stainless steel foil. In various alternative implementations, substrate 101 may be made of other metals, including but not limited to, titanium, copper, aluminum, beryllium and the like. Materials suitable for the substrate 101, i.e., the web, are those that have an elastic modulus of elasticity and that fails plastically. As indicated, in various implementations of the invention, the substrate 101 is relatively thin, such as for example, less than or equal to about 2-10 mils. However, other suitable thicknesses may also be used. Typically, the substrate is thin enough to be flexible. Back electrical contact layer 103 provides electrical contact to allow electrical current to flow through the PV cell, and may be made of any appropriate material, e.g., molybdenum, niobium, copper, silver, etc. A p-type semiconductor layer 105 is deposited on back electrical contact layer 103 and an n-type semiconductor layer 107 is deposited on p-type semiconductor layer 105 to complete a p-n junction. According to various implementations, any suitable semiconductor materials, such as CIGS, CIS, CdTe, CdS, ZnS, ZnO, amorphous silicon, polycrystalline silicon, etc. are used for layers 105 and 107. For example, the p-type semiconductor layer 105 may be CIGS or CIS, and the n-type semiconductor layer 107 may be CdS or a cadmium free material, such as ZnS, ZnO, etc. Top transparent electrode layer 109 is deposited on the p-n junction. In certain implementations, top transparent electrode layer 109 is a transparent conducting oxide (TCO), for example, zinc oxide, aluminum-doped zinc oxide (AZO), indium tin oxide (ITO) and gallium doped zinc oxide. As noted above, in some embodiments this PV material stack is about 2 micrometers thick.

After deposition of the thin films on the substrate 101, the substrate having thin films deposited thereon may be cut to wholly or partially define cells or modules. In certain implementations, a substrate is cut length wise into multiple cell-width strips. This is illustrated in FIG. 1, which shows substrate 101 cut lengthwise to define multiple cell-width strips 117. For example, a substrate having a width (x-dimension) of 1 m is cut into strips of approximately 35 mm. Long cell-width strips may then be further cut to define individual cells. This is just an example of cutting scheme that may be used; according to various implementations, a substrate having thin films deposited thereon may be cut in a variety of manners to wholly or partially define cells. A typical PV module may include several such PV cell strips which are connected in series. To implement such an arrangement, small wires may be used to electrically connect the topmost conductive layer, e.g., the positive terminal, of a PV cell strip with the bottommost layer, e.g., the negative terminal, of a neighboring PV cell strip.

Once connected, the electrically connected PV cell strips may be laminated and/or encapsulated by one or more materials, such as a polymer, in order to create a PV module. This encapsulation onto the PV cells and the interconnecting wires may adversely affect the interconnecting wires, as discussed below.

Due to the layered nature of PV cells, existing shear-cutting technologies may be unsuited for cutting the PV cell strips. This is because the shearing action may cause material from one layer to smear across the cut face and contact another layer, which can produce electrical edge shunts. For example, edge shunts can develop along a cut line due to a curling of the conductive substrate at the edge and resulting contact between the conductive substrate and TCO layer at the edge. Such shunts may compromise PV performance by, for instance, degrading a cell, reducing its efficiency, and it some cases rendering the cell un-useable.

An alternative cutting method to shear-cutting is burst-cutting a PV stack into PV cell strips. One potential advantage of burst-cutting is that the creation of edge shunts may be reduced or eliminated. In some existing burst-cutting methods, a material is cut by causing a blade to apply enough stress to exceed the yield limit of the material as defined in the stress-strain curve for that material such that the material ruptures at the stress concentration. However, burst-cutting of a PV stack may have its disadvantages, such as plastic deformation of the material at the fracture site, e.g., the creation of burrs on the resulting PV cell strips. When manufacturing a PV module that includes two or move PV cells, i.e., PV cell strips, the PV cells may need to be electrically connected such that the front of one PV cell is electrically connected to the back of a neighboring, e.g., adjacent, PV cell. Such electrical connection may be accomplished using small or thin connecting wires. These wires may be in a traditional form, such as a single piece of metal that is a thin flexible thread or rod, and these wires may also be formed by depositing conductive material over an insulating substrate. For example, the interconnecting wires may be formed by depositing copper and/or silver onto a PET (e.g., polyethylene terephthalate) substrate. The plastically deformed burrs of the PV cell strips may cause undesirable wear, tear, and failure of the connecting wires which in turn adversely affects the PV module.

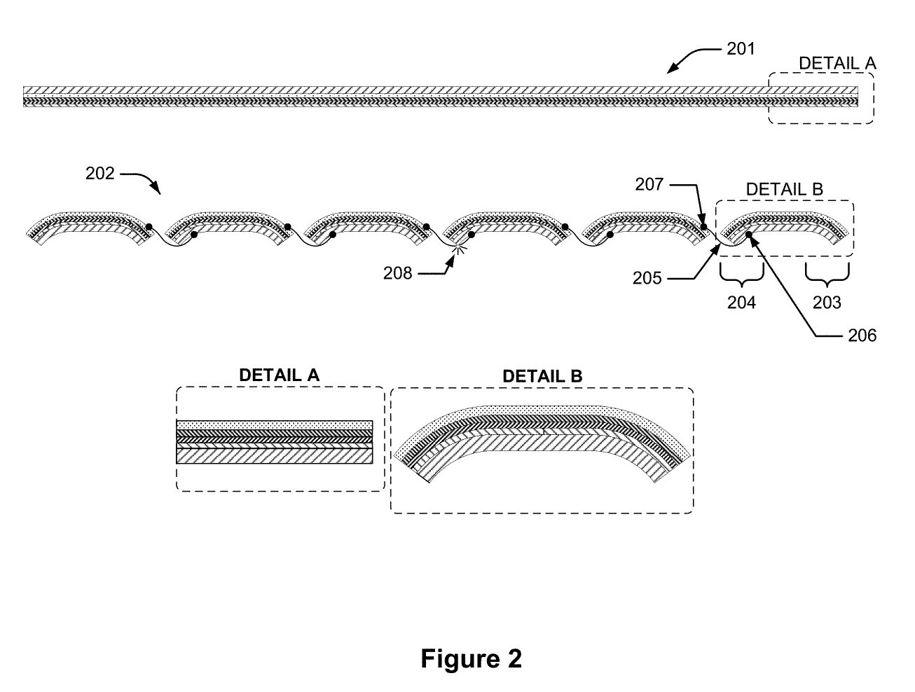

For instance, cutting a PV cell into PV cell strips using a typical burst-cutting method may create PV cell strips that have dual down-burrs on the parallel edges or sides of each PV cell strip. FIG. 2 depicts an example PV stack and example cross-sections of PV cell strips that have a dual down-burr. As can be seen, PV web 201 has been cut into PV cell strips 202 with a typical burst-cutting method. Each PV cell strip 202 includes two down-burrs 203 and 204. Each PV cell strip 202 may be linked to a neighboring PV cell strip 202 by a conductor, such as connecting wire 205 which may be electrically connected 206 with the bottom side of one PV cell strip 202 and electrically connected 207 with the top side of a neighboring PV cell strip 202. In a PV module, the down-burrs may interact with the small wires used to implement this circuit in undesirable ways, e.g., by cutting or increasing wear and tear on the wires. For example, wire 205 linking the two middle PV cell strips 202 has been broken at 208 due to stresses introduced by contact with down-burr 204. Such stresses may be applied in the PV module during and/or after the cells and interconnecting wires have been encapsulated, or further processed with additional layers placed onto and/or around them.

According to some embodiments, the methods and apparatuses described herein may have one or more of the following advantages. For example, the methods and apparatuses may be advantageously used to fabricate PV stacks that are to be encased by flexible encasement materials, such as polymers. In the past, the majority of PV modules were encased by rigid materials and when cutter apparatuses and methods for cutting PV stacks for rigid PV modules were used for cutting PV stacks that were to be used in PV modules encased by flexible materials, it was discovered that there was wear, tear, and damage to the interconnect wires between the PV stacks in the flexible material-encased PV module. Such wear, tear, and damage to the interconnect wires was caused by, among other things, adverse interactions between the down-burrs of the PV stack and the interconnect wires because, for instance, thermal expansion of the PV module was less contained and constrained by the flexible encasement materials than with the glass encasement. The cutting apparatuses and methods disclosed herein are able to cut a PV stack with resulting down-burrs that cause little to no interference with the interconnect wires in PV modules that have flexible encasement materials.

Another advantage of the methods and apparatuses described herein may also include reducing and/or eliminating the development of edge shunts along cut regions of the PV cell strips and the wear, tear, and failure of interconnect wires between PV cell strips by causing a burst-cut of the PV stack while minimizing or eliminating the plastic deformation that creates one of the down-burrs. Some embodiments of the present disclosure therefore relate to methods and apparatuses for reducing and/or eliminating the development of edge shunts along cut regions of the PV cell strips, as well as for creating a PV cell strip with two down-burrs that are configured to reduce or eliminate the wear, tear, and failure of interconnect wires between PV cell strips. In some embodiments, an apparatus may be configured to cause a burst fracture of the material of a PV cell such that the material on one side of the fracture site is plastically deformed but on the other side the material is elastically deformed and/or is minimally plastically deformed. Such configuration may result in an elastic deformation of the material such that the length and/or down angle of a down-burr is significantly reduced or eliminated.

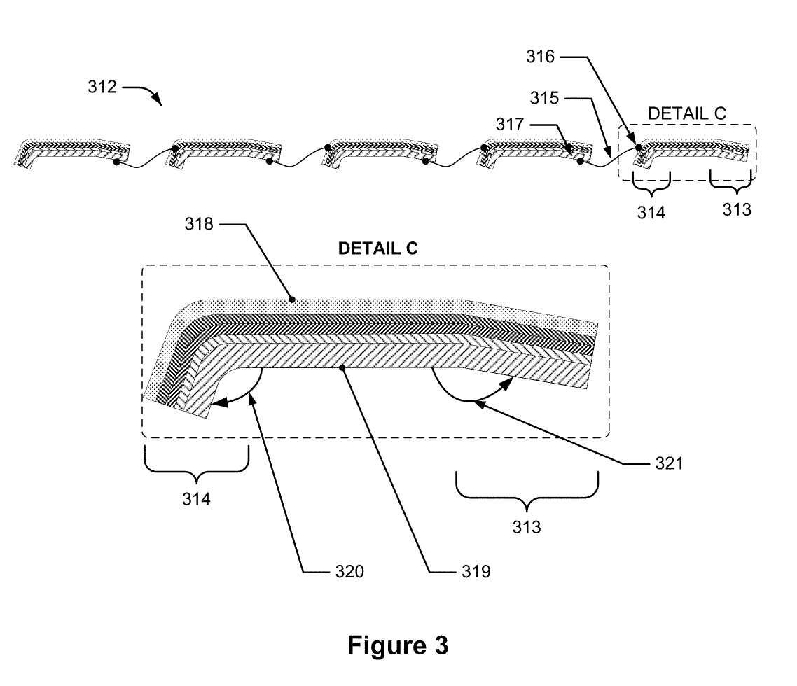

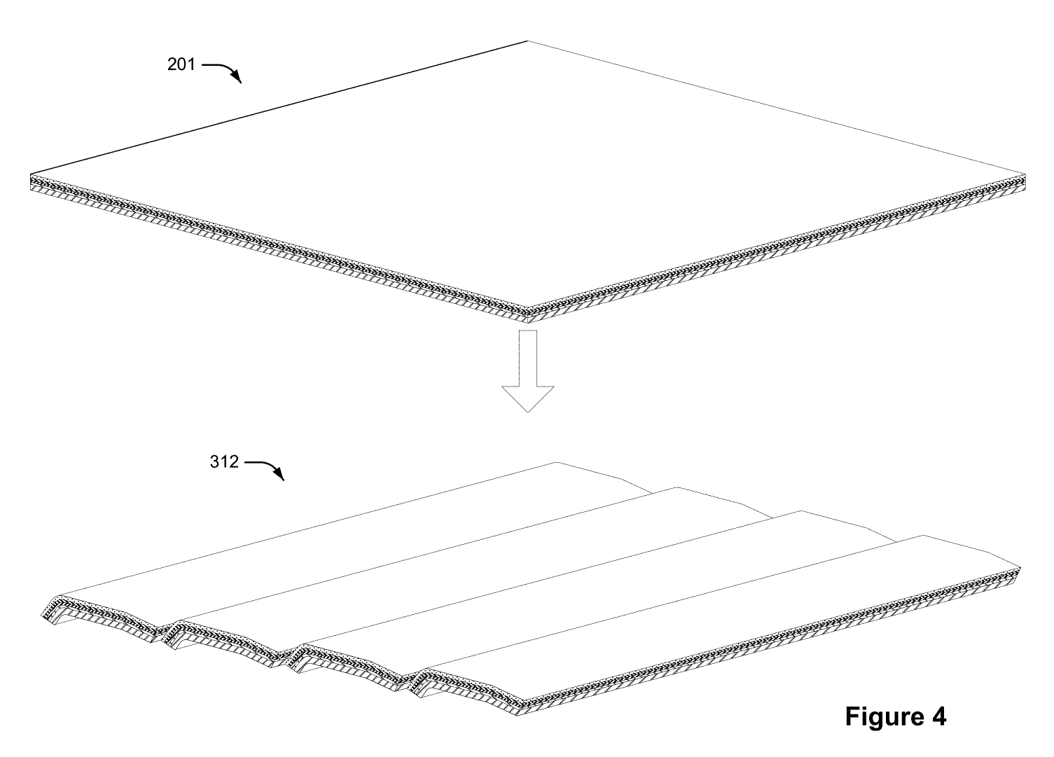

For instance, a down-burr that is elastically deformed during burst-cutting such that after cutting it is angled away from the bottom face of the PV cell strip at an angle between about 160 degrees and about 180 degrees may limit the interference and interaction of this down-burr with the interconnecting wire such that wear, tear, and failure of interconnecting wires is greatly reduced than with PV cell strips created with other cutting methods. For example, FIG. 3 depicts a cross-sectional view of example PV cell strips that may be produced according to the present disclosure. FIG. 4 depicts an isometric view of PV stack 201 and PC cell strips 312. As can be seen, FIG. 3 includes five PV cell strips 312 that are electrically interconnected with each other. As seen in Detail C, each PV cell strip 312 includes a first down-burr 314, and second down-burr 313, a substantially planar top face 318, and a substantially planar bottom face 319 (each face may also be considered to include the down-burrs). The first down-burr 314 is angled away from the bottom face 319 by a first angle that may be between about 90 degrees and about 150 degrees. In some embodiments, the first angle may be an obtuse angle. In some embodiments, the length of the first down-burr may be between about 100 micrometers and about 200 micrometers. During the burst-cutting, the material of the PV cell strip 312 may be plastically deformed such that the first down-burr 314 is created.

The second down-burr 313 is angled away from the bottom face 319 by a second angle 321 that is larger than the first angle 320. In some embodiments, the second angle may be between about 160 degrees and about 180 degrees, including about 170 degrees. Additionally, in some embodiments, the length of the second down-burr may be between about 1000 micrometers and about 1500 micrometers. In contrast to the first down-burr 314, the second down-burr 313 is deformed during the burst cutting in such a way that it elastically recovers and is therefore minimally or not plastically deformed. Interconnecting wire 315 is electrically connected 317 to the bottom face 319 (which may include second down-burr 313) on the side of the PV cell strip 312 that has the second down-burr 313 and electrically connected 316 to the top face 318 on the side of the PV cell strop 312 that has the first down-burr 314. According to some of the embodiments herein, the wear, tear, and failure of the interconnecting wire 315 may be reduced by using PV cell strips 312 in a PV module that is encased by flexible material.

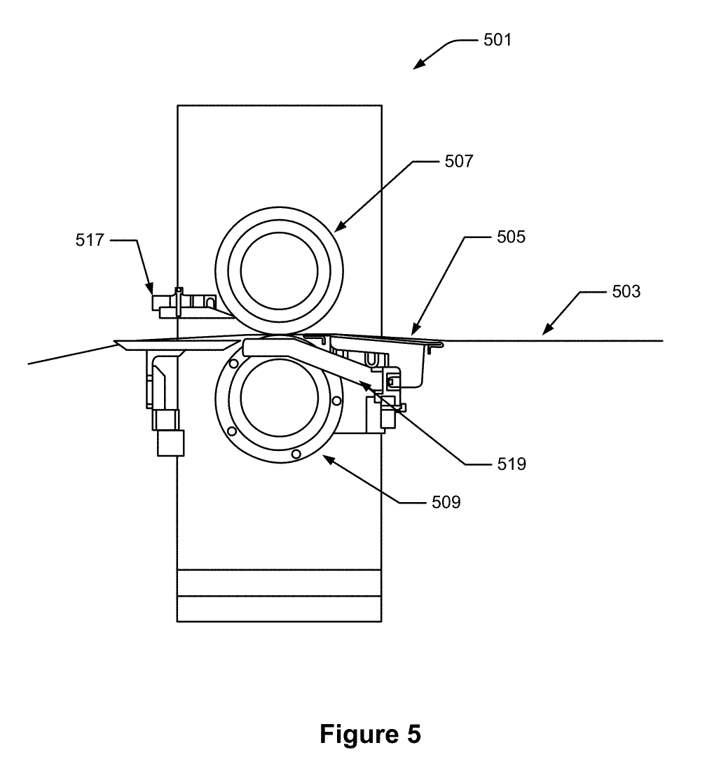

Various methods and apparatuses described herein may be used to produce the PV cell strips with two down-burrs. FIG. 5 depicts a side view of an example cutting apparatus 501 that may be used to cut a substrate/thin film stack into multiple cell-width sized strips as depicted schematically in FIG. 1. An uncut substrate 503 having a film stack thereon is fed to the cutter by in-feed 505. The in-feed 505 and cutting apparatus may be configured for various substrate sizes. Substrate 503 may of any width, e.g., between about 0.3 meters and 3 meters, e.g., 1 meter, though other sizes may be used as appropriate. In certain implementations, substrate 503 is fed into the cutter after emerging from a thin film deposition chamber or chambers. According to various embodiments, the substrate 503 may be a continuous roll or web, or may be in fed into the cutter 501 as a discrete sheet. For example, in one processing scheme, thin film materials are deposited on a vertical web of stainless steel foil, with transverse cuts then made to form sheets of the steel substrate/film prior to being fed into the cutter. The unwound roll or sheet may be supported by a support (not shown) while being fed into cutter 501. Cutter 501 includes two rotating cylinders, between which substrate 503 is fed: cutting cylinder 507 and support cylinder 509. In certain implementations, substrate 503 is continuously fed into the cutter, with rotating blades on cutting cylinder 507 cutting the substrate into strips as the substrate is moved through the cutter by the rotating support cylinder 509. The cut strips exit the cutter via out-feed 511.

In certain implementations, a bar parallel to the cutting cylinder is positioned above the substrate plane on the out-feed side to knock down stray strips that fly up after emerging from the cutter. For example, the cutting apparatus depicted in FIG. 5 includes knock-down bar 517. The apparatus in FIG. 5 also includes a finger feature 519 that keeps strips from rewrapping. Additional details of cutting apparatus 501 are described further below.

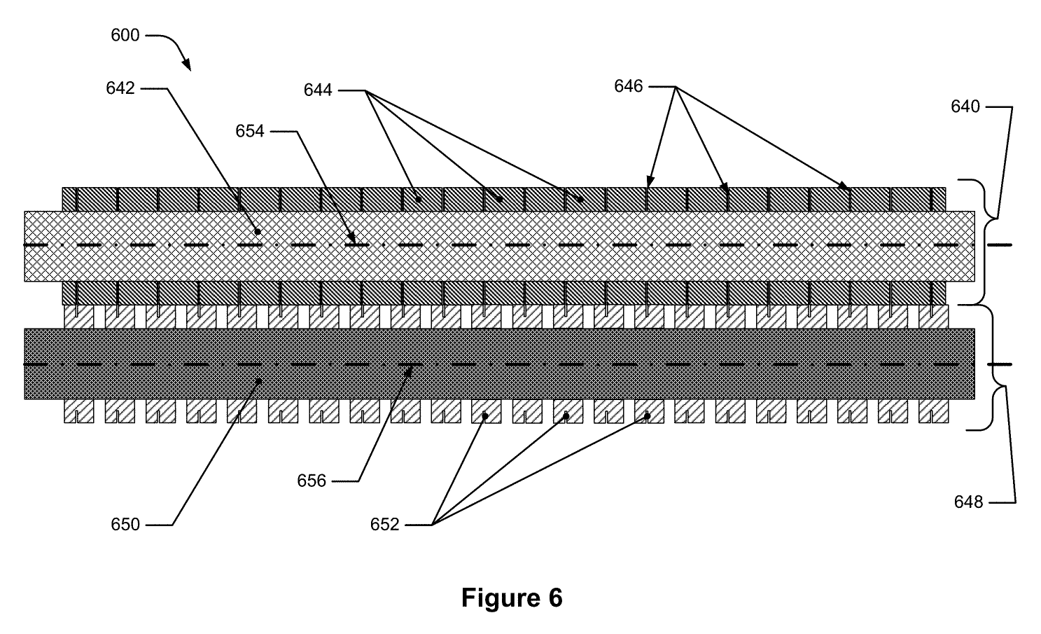

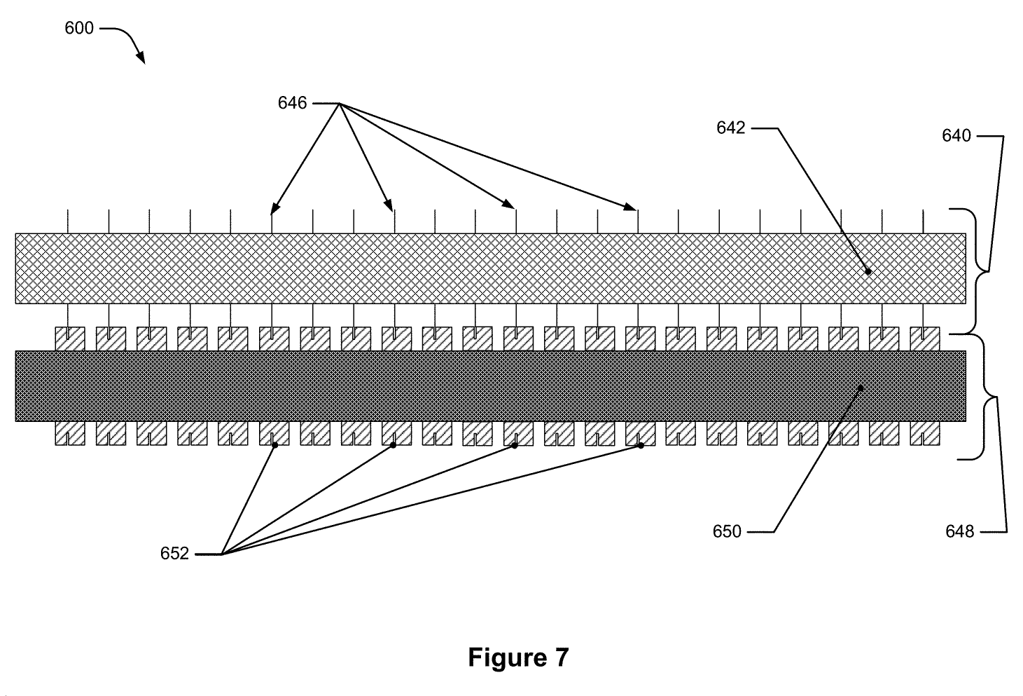

FIG. 6 depicts a sectional front view of example cutter mechanism that includes a cutting cylinder and a support cylinder. As can be seen, the cutting cylinder 640 of the example cutter mechanism 600 includes a cutter arbor 642, a plurality of spacer rollers 644, and a plurality of knife cutter rollers 646 arranged on the cutter arbor 642 such that one knife cutter roller 646 is in between two spacer rollers 644. FIG. 7 depicts the example cutter mechanism of FIG. 6 with the spacer rollers removed such that the plurality of knife cutter rollers 646 of the cutting cylinder 640 can be seen. The support cylinder 648 includes a support arbor 650 and a plurality of support rollers 652. Each support roller 652 is coupled to the support arbor 650 such that the support rollers 652 are coaxial with each other.

Referring back to FIG. 6, cutter arbor 642 and support arbor 650 may be mounted within a cutting apparatus such that the rotational axes 654 and 656 of each arbor, respectively, are parallel and offset. In some embodiments in which cutter arbor 642 and/or support arbor 650 are substantially cylindrical (e.g., within +/−5% of round), rotational axes 654 and/or 656, respectively, may be coaxial with the cylinder central axes. In some embodiments of the cutting mechanism 600, at least one of cutter arbor 642 and support arbor 650 may be movable to allow the separation distance between the rotational axes 654 and 656, respectively, of cutter arbor 642 and support arbor 650 to be adjusted. Cutter arbor 642 and support arbor 650 may be rotatable about rotational axis 654 and rotational axis 656, respectively. One or both of cutter arbor 642 and support arbor 650 may be rotationally driven by a motor or other drive system.

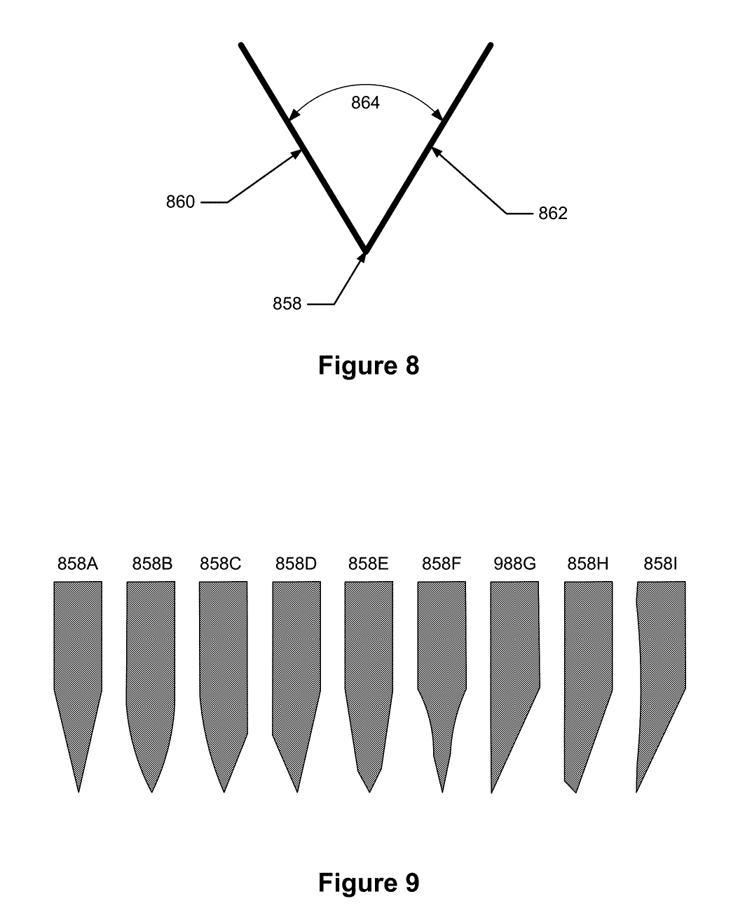

Each knife cutter roller 646 may be a substantially circular roller (e.g., within +/−5% of round), which in some embodiments may be considered a circular disk. In some embodiments, the diameter of each knife cutter roller may be significantly closer to round, such as less than 0.02% of round. For example, a knife cutter roller with a diameter of 5.0000 inch diameter may be within +/−0.0003 inches. Each knife cutter roller 646 has a substantially circular (e.g., within +/−5% of round, or smaller such as less than 0.02% of round) knife edge that forms the outer-most circumferential boundary of the knife cutter roller 646. For example, when viewed along the center axis of the knife cutter roller, the knife edge is a substantially circular edge that is the outer-most circumferential boundary of the knife cutter roller. This knife edge may be considered a “blade” of the knife cutter roller 646 and may take the shape of any known knife or blade edge. For example, the knife edge may be a sharp edge formed by the intersection of two surfaces. FIG. 8 depicts a cross-sectional view of an example knife edge of an example knife cutter. As can be seen, a knife edge 858 is formed at the intersection of two surfaces of the knife cutter roller, i.e., a first surface 860 and a second surface 862. In some embodiments, these surfaces may be considered part of the knife edge itself. The knife edge 858 may be a sharp edge or may be a rounded edge that has a third radius that is substantially smaller than the first radius (e.g., less than about 15% of the first radius), such as between about 0.0001 inches and about 0.0005 inches. In some embodiments, the third radius may be substantially smaller than the vertical depth of the first edge, which is discussed below (e.g., less than about 15% of the vertical depth). In some embodiments, the two surfaces 860, 862 of the knife cutter roller may be planar surfaces, like that depicted in FIG. 8, or they may be of varying geometries and configurations. For instance, FIG. 9 depicts various example knife edges, such as a V ground edge 858A, a convex edge 858B, an asymmetrical semi-convex edge 858C, an asymmetrical V edge 858D, a compound (double) bevel edge 858E, a hollow ground edge 858F, a chisel edge 858G, a chisel with back bevel edge 858H, and a chisel with urasuki edge 858I, for example. Referring back to FIG. 8, an internal angle 864 between the first surface 860 and the second surface 862 may be less than 180 degrees and in some such embodiments, may be an acute angle, like that shown in FIG. 8.

The knife cutter rollers 646 are coupled with the cutter arbor 642 such that the knife edges are coaxial with each other and so that knife cutter rollers 646 rotate with the cutter arbor 642. In some embodiments, cutter arbor 642 may not be cylindrical, e.g., a square shaft; in such embodiments, knife cutter rollers 646 may be mounted to cutter arbor 642 such that the outer surfaces of knife cutter rollers 646, e.g., the knife edges 658, are concentric with rotational axis 654. Knife cutter rollers 646 may be keyed to cutter arbor 642 or otherwise prevented from rotating with respect to cutter arbor 642. Knife cutter rollers 646 may be spaced at approximately the same spacing as the desired width of the PV cell strips which may be produced using the cutting apparatus; it should be understood that “spacing,” in this context, refers to the spacing between a reference point on a given knife cutter roller 646 and a corresponding reference point on a neighboring knife cutter roller 646. For instance, the knife cutter rollers 646 may be axially spaced apart from each other by a substantially equal distance (e.g., within +/−5% of each other).

Each knife cutter roller 646 may be made from a single piece of material or may be comprised of multiple parts. For instance, a knife cutter roller may be made from a single material, such as stainless steel, and its knife edge may be formed by any known machining process. In some other embodiments, the knife cutter roller may be made from at least two parts, such as an internal disk or mounting plate to which a separate knife edge part may be affixed.

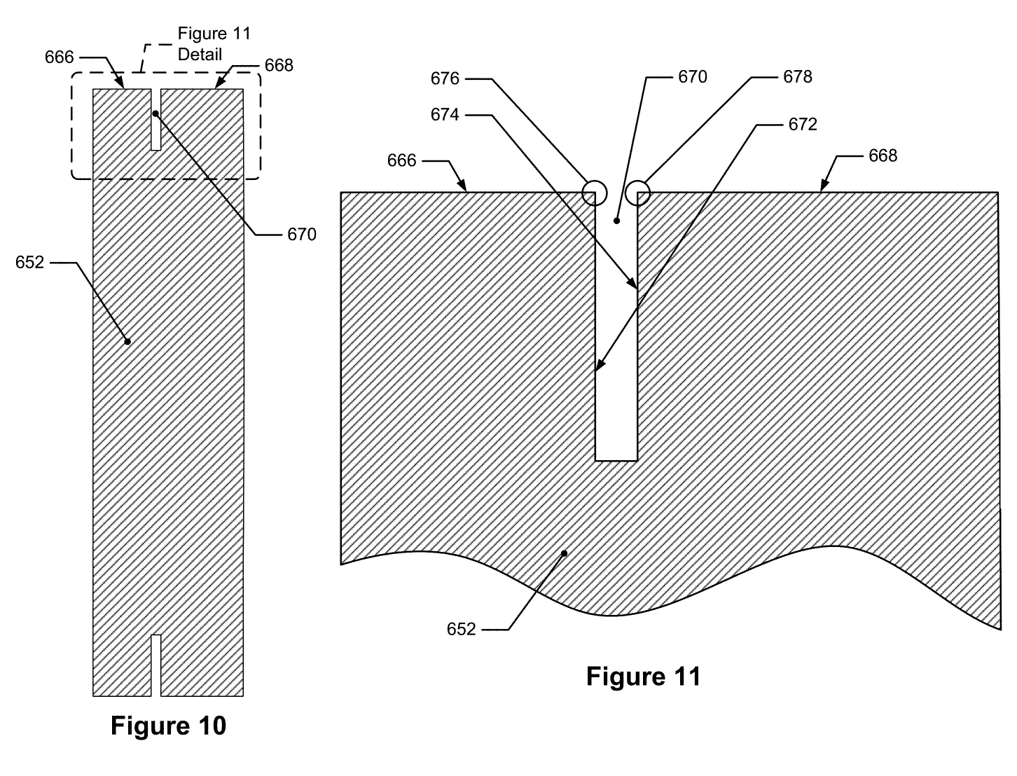

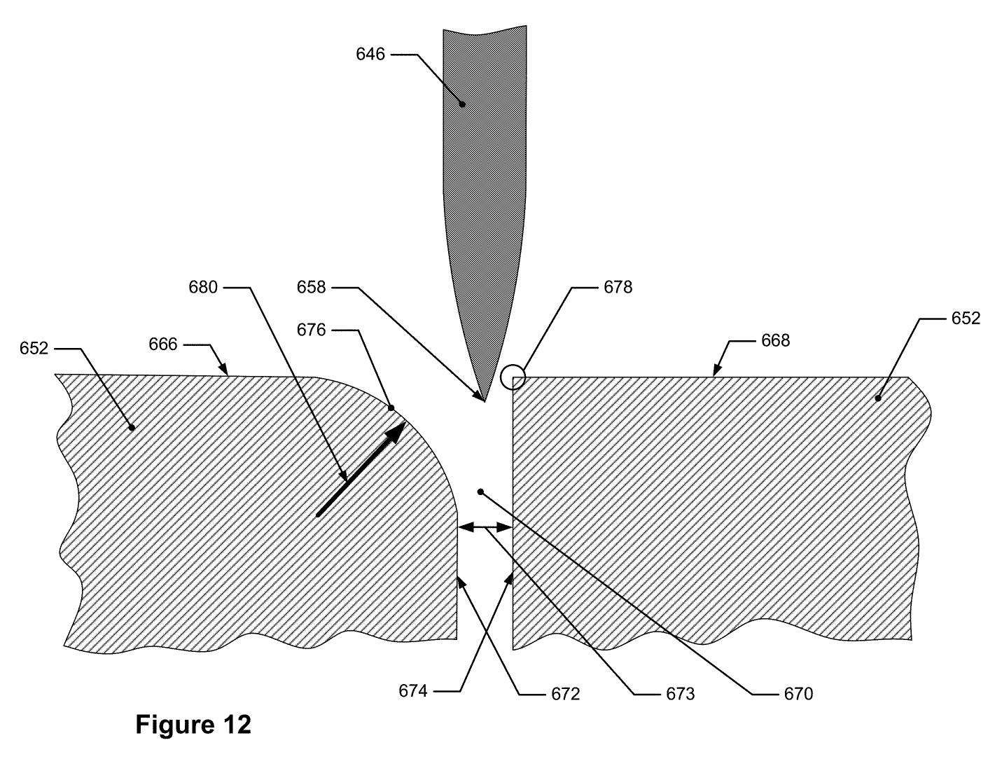

Referring back to FIG. 6, as stated above the support cylinder 648 includes the support arbor 650 and the plurality of support rollers 652 that are each coupled to the support arbor 650 such that the support rollers 652 are coaxial with each other and such that the support rollers 652 rotate with the support arbor 650. FIG. 10 depicts a cross-sectional view of an example support roller. Each support roller 652 may have a substantially cylindrical first outer surface 666, a substantially cylindrical second outer surface 668, and a circumferential gap 670 between the first outer surface 666 and the second outer surface 668. The first outer surface 666 and second outer surface 668 may be coaxial with each other and may have a substantially equal outer circumference (e.g., within +/−5% of each other). FIG. 11 depicts a detail view of a section of the support roller of FIG. 10. As can be seen, the circumferential gap 670 is at least partially defined by a first side 672 and a second side 674 that face each other and are offset from each other. “Face” in this context means that two surfaces are oriented towards each other such that a line extending from at least one point on one of the surfaces in a direction normal to that surface intersects with a point on the other surface. “Face” in this context may also include two surfaces that are parallel or substantially parallel to each other (substantially here means within 10% of parallel, e.g., +/−9° of parallel). In FIG. 11, the first side 672 and the second side 674 are substantially parallel to each other. In some other embodiments, they may not be substantially parallel to each other.

The circumferential gap 670 may be further defined by at least a first edge 676, which is where the first side 672 intersects with the first outer surface 666, and by a second edge 678, which is where the second side 674 intersects with the second outer surface 668. As discussed below, the first edge 676 is rounded with a first radius and the second edge is sharp or has a second radius that is substantially smaller than the first radius (e.g., the second radius is less than about 10% of the first radius). For illustration purposes, the first edge 676 and the second edge 678 are both depicted as sharp edges in FIG. 11.

It should be noted that the support roller 652, like the knife cutter roller, may be made from a single piece of material or may be made from multiple parts. For example, the support roller may be made from a single piece of material that begin as a cylinder and the circumferential gap (e.g., groove) is created in the cylinder by the removal of some material of the cylinder, e.g., by a lathe or mill. In some such examples, the initial single cylindrical outer surface of the support roller is separated into two outer surfaces, e.g., the first outer surface and the second outer surface, by the creation of the gap. In another example, the support roller may be made of two cylinders, disks, flanges, or other pieces that are separated by a spacer and the circumferential gap is created by the space between the two cylinders, disks, flanges or other pieces. For instance the first outer surface may be part of a first disk and the second outer surface may be part of a second disk which are separated by a spacer disk, with at least these three parts making up the support roller.

Referring back to FIG. 6, the support arbor 650 may not be cylindrical, e.g., a square shaft; in such embodiments, support rollers 652 may be mounted to support arbor 650 such that the outer surfaces of support rollers 652 are concentric with rotational axis 656. Support rollers 652 may be keyed to support arbor 650 or otherwise prevented from rotating with respect to support arbor 650. Support rollers 652 may be spaced at approximately the same spacing as the desired width of the PV cell strips which may be produced using the cutting apparatus; it should be understood that “spacing,” in this context, refers to the spacing between a reference point on a given support roller 652 and a corresponding reference point on a neighboring support roller 652.

The example cutting mechanism 600 may be configured and arranged such that one knife edge is positioned in the circumferential gap of one corresponding support roller. For instance, the knife cutter rollers and the support rollers are spaced along their respective arbors, and the cutting arbor and support arbor are offset from each other, such that one knife cutter roller is aligned with and extends into the circumferential gap of one support roller. In such an example, referring back to FIG. 7, the knife cutter rollers 646 are axially spaced along the cutter arbor 642, and the support rollers are axially spaced along the support arbor 650, such that one knife cutter roller is aligned with and extends into the circumferential gap of one support roller. This alignment may be seen when viewed at an angle perpendicular to a plane that is coplanar with both the first rotational axis 654 of the cutter arbor 642 and the second rotational axis 656 of the support arbor 650, like the viewing angles of FIGS. 6 and 7. Additionally, the cutter arbor 642 and support arbor 650 are offset such that each knife edge extends into, i.e., is positioned in the circumferential gap of one corresponding support roller. For example, when viewed along the first or second rotational axes, 654 or 656, respectively, the knife cutter rollers 646 overlap with the support rollers 652 such that the each knife edge is positioned in the circumferential gap of one corresponding support roller. The cutter arbor 642 and the support arbor 650 are also offset from each other in a non-interfering manner and such that the web may be fed between the cutter arbor 642 and the support arbor 650, e.g., pass through a transport gap between these two rollers, as discussed below.

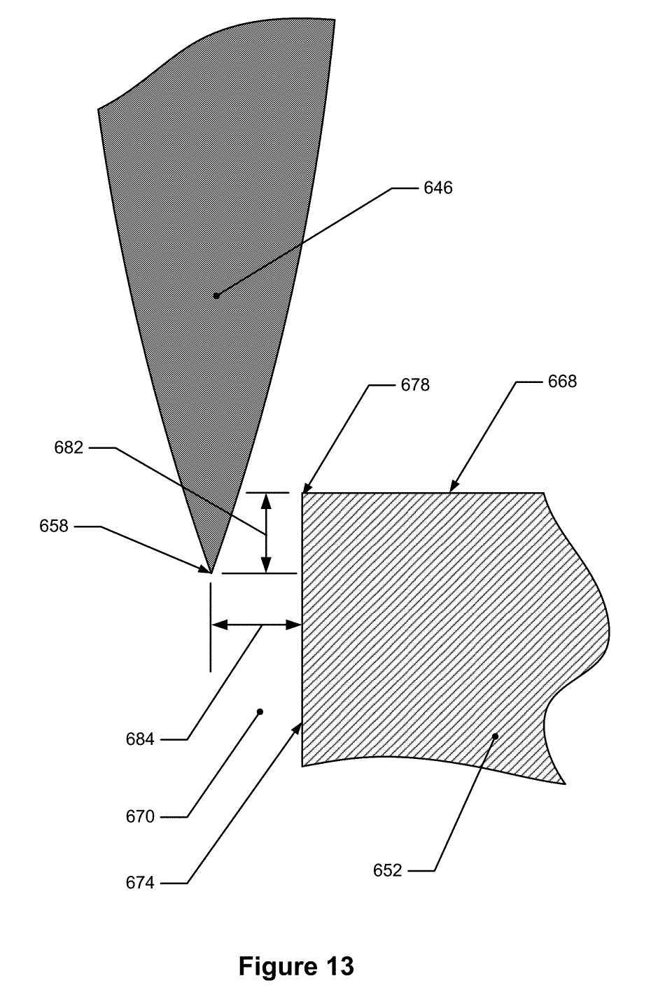

The configuration of the support roller, knife cutter roller, and the arrangement of the rollers and arbors will now be discussed. FIG. 12 depicts a detail view of portions of one support roller and one cutter roller of FIG. 6; a portion of one knife cutter roller 646 and portions of one support roller 652 are shown and the spacer rollers 644 of the cutter cylinder 640 are not depicted for clarity purposes. With regard to the support roller 652 in FIG. 12, as described above, the circumferential gap 670 is defined, at least in part, by the first edge 676 that has a first radius 680 and by the second edge 678 that is sharp or that has a second radius that is substantially smaller than the first radius 680 (e.g., less than about 10% of the first radius 680). Although the below discussion may describe the second edge as sharp, it is to be understood that the second edge may be either a sharp edge or an edge with a second radius that is substantially smaller than the first radius. The first edge 676 is where the first side 672 intersects with the first outer surface 666 and the second edge 678 is where the second side 674 intersects with the second outer surface 668. The first edge 676 may have a radius that ranges from between about 0.010 inches to about 0.060 inches, including 0.040 inches. In some embodiments, the second edge 678 may have no radius, i.e., it is sharp and not rounded. The sharp edge, as stated above, is where two surfaces intersect and in some embodiments, the internal angle of the two intersecting surfaces may be less than 180 degrees and may be, for example, substantially 90 degrees (e.g., within +/−5% of normal). In some other embodiments, the second edge 678 may have a small second edge radius that is substantially less than the first radius 680, e.g., less than about 10% of the first radius 680, and in some embodiments may be about 0.0005 inches or smaller to about 0.00005 inches.

As stated above, the first edge 676 may be rounded with a first radius, and in some such embodiments, the rounding of the first edge 676 may be a non-circular rounding or a variable-radius curved surface (including, for instance, elliptical or parabolic curves). In these embodiments, the first radius may be considered the average nominal radius of the non-circular rounding or variable-radius curved surfaces forming the first edge 676 which is the average of the radii for each curved surface that make-up the first edge 676. In some of the embodiments in which the second edge has a second radius that is substantially smaller than the first radius, the first radius is considered the average nominal radius of the non-circular rounding or variable-radius curved surfaces forming the first edge 676.

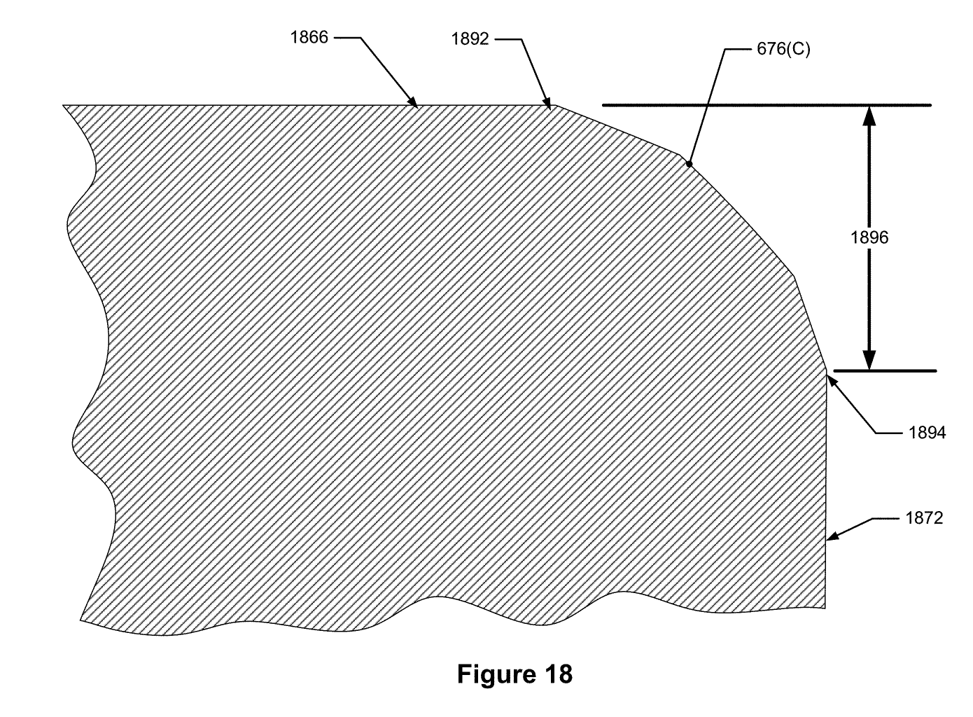

In some other embodiments, the first edge 676 may have a profile that is not rounded and instead may be of varying geometries that are configured to still have the same effect on the resulting down-burr of the PV web as described herein. These geometries may include, for instance, two or more facets, a chamfer, or a combination of such surfaces with curved surfaces (e.g., a chamfer that transitions to a curved surface). FIG. 17 depicts four example first edges of the support rollers such as 676(C) illustrating a geometry with facets (e.g., 3 planar surfaces), 676(D) depicting a noncircular parabolic geometry, 676(E) illustrating a chamfer, and 676(F) illustrating a combined chamfer and curve. In some embodiments that have a chamfer, the angle of such chamfer, as measured with respect to the first outer surface as seen in FIG. 17 with the angle labeled as 1790, may range, for instance, between about 0 degrees to about 100 degrees and the length of such chamfer may range, for example, between about 0.10 inches to about 0.010 inches.

In some of the embodiments in which the second edge has a second radius and the first edge has a profile that is not rounded, the second radius may be referenced against a vertical depth of the first edge as described herein. FIG. 18 depicts a first edge of FIG. 17 that has facets. As can be seen, the first edge 676(C) intersects with the first outer surface 1866 at a first point 1892 and intersects with the first side 1872 at a second point 1894. The vertical depth 1896 of the first edge 1892 may be considered the distance between the first point 1892 and the second point 1894 in a direction perpendicular to the first and/or second rotational axes of the cutter arbor and/or support arbor, respectively. In such embodiments, the second radius is substantially smaller than the vertical depth of the first edge (e.g., less than 10%). In some such embodiments, the vertical depth range may be between about 0.010 inches to about 0.060 inches, including 0.040 inches and the second radius may again range between about 0.0005 inches or smaller to about 0.00005 inches.

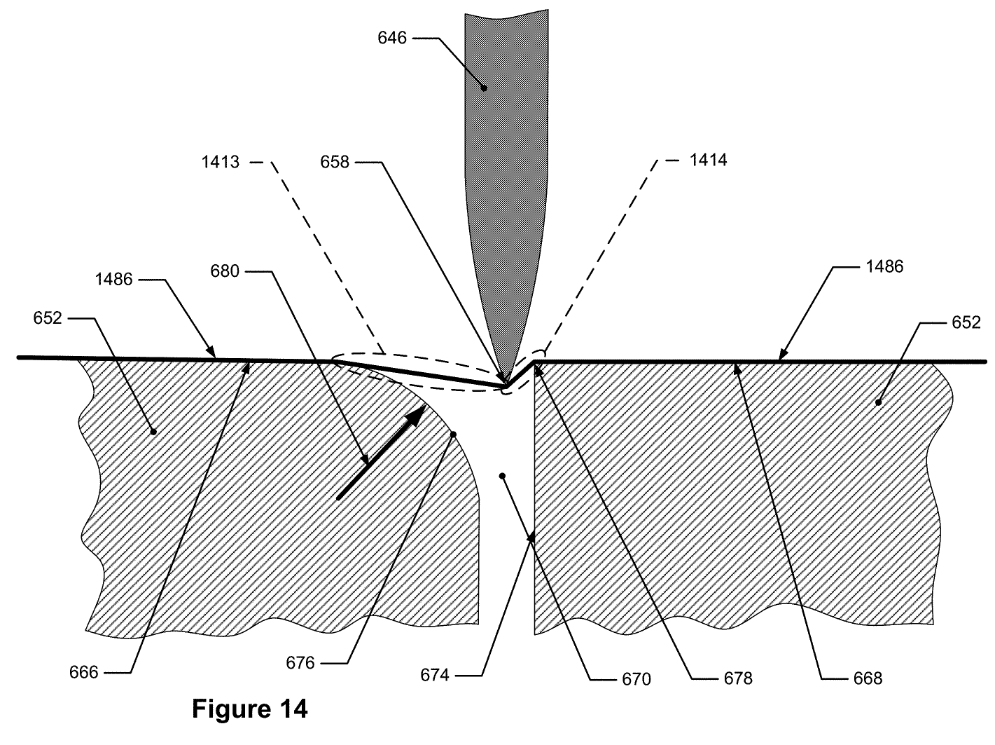

Referring back to FIG. 12, the knife edge 658 of the knife cutter roller 646 is seen positioned in the circumferential gap 670. The position of the knife edge 658 in the circumferential gap may be based, at least in part, on a penetration distance which may be the distance between the knife edge 628 and the first outer surface 666 and/or the second outer surface 668; the position may be based, at least in part, on an axial separation distance from the first side and/or second side of the support roller 652. FIG. 13 depicts a detail view of the knife cutter roller and support roller of FIG. 12; only a part of the right portion of the support roller 652 is shown for clarity of illustration. As can be seen, the knife edge 658 is positioned in the circumferential gap 670 by a first penetration distance 682 which is the distance between the knife edge 658 and the second outer surface 668, which may be measured in a direction perpendicular to the first and/or second rotational axes of the cutter arbor and/or support arbor, respectively. This may also be considered in a direction towards the rotational axis 656 of the support arbor 650 such that the knife edge 658 is closer to the rotational axis 656 than the second outer surface 668 is to the rotation axis 656, as referenced in a direction perpendicular to the rotational axis 656 of the support arbor 650.

Additionally, the knife edge 658 is positioned in the circumferential gap 670 by a first separation distance 684 which is the distance between the knife edge 658 and the second side 674, which may be measured in a direction parallel to the first and/or second rotational axes of the cutter arbor and/or support arbor, respectively. In some embodiments, the first penetration distance 682 may range from between about 0.010 inches to about 0.040 inches, including about 0.020 inches, and the first separation distance 684 may range from between about 0.050 to about 0.090, including about 0.075 inches. The penetration distance may be adjusted by adjusting the offset between the rotational axes of the cutter arbor and the support arbor, while the separation distance may be adjusted by adjusting the axial spacing of the support rollers and/or the knife cutter rollers on their respective arbors. Although the penetration distance and the separation distance are described in relation to the second outer surface and the second side, respectively, these distances may also be similarly measured in relation to the first outer surface and the first side, respectively. The first side 672 and the second side 674 may be separated from each other by a gap distance 673 depicted in FIG. 12; this gap distance 673 may range from between about 0.100 inches to about 0.002 inches, including about 0.150 inches.

The apparatus disclosed herein is configured to cut the PV web into PV cell strips with two of the aforementioned down-burrs by causing a burst fracture of the material of the PV stack in such a manner that the material on one side of the fracture site is plastically deformed (and thus forms the down-burr that is angled between about 90 degrees and about 150 degrees from the bottom surface of the web, e.g., the first down-burr 314 of FIG. 3) and the material on the other side of the fracture side elastically deforms and/or is minimally plastically deformed (and thus forms the other down-burr that is angled between about 180 degrees and about 160 degrees from the bottom surface of the web, e.g., the second down-burr 313 of FIG. 3). Particular arrangements and configurations of the knife cutter rollers and support rollers, individually and in relation to each other, enable the apparatus to cause the burst fracture of the material of the PV stack and thereby cut the PV web into PV cell strips with the desired shape. For example, some such arrangements include the circumferential gap having the first edge that is rounded and a second edge that is sharp, as well as the shape of the knife edge and the penetration distance and first separation distance of the knife edge.

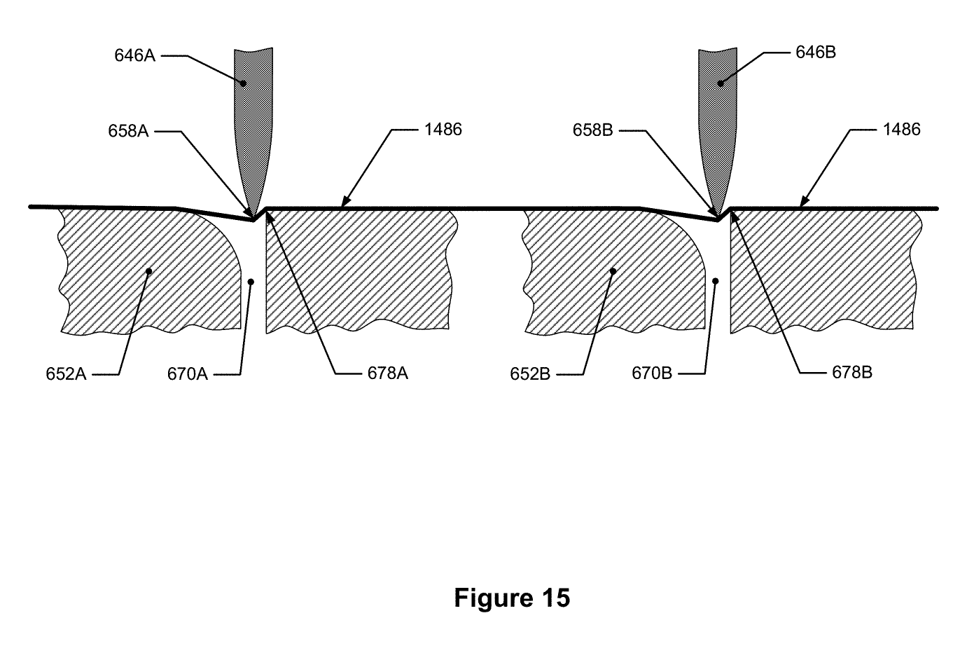

FIG. 14 depicts the detail view of FIG. 12 along with an example web. As can be seen, the web 1486 is positioned in-between the knife cutter roller 646 and the support roller 652 and may be considered running (e.g., being fed through these rollers) in a direction perpendicular to the plane of the page. It may also be considered that the web 1486 passes through a transport path, or transport gap, between the cutting cylinder and support cylinder such that the transport path may be bounded, at least in part, by the plurality of knife edges, first outer surfaces of the support rollers, second outer surfaces of the support rollers, and the circumferential gaps of the support rollers. The first outer surface 666 and the second outer surface 668 of the support roller 652 are configured to contact and support the web, as shown in FIG. 14. Although the spacer rollers are not shown in FIG. 14, it should be noted that in some embodiments the spacer rollers do not contact the web; in some such embodiments the only portion of the cutter cylinder to contact the web 686 are the knife cutter rollers 646 and in some such embodiments that contact may be only by the knife edge 658. The knife edge 658 is positioned in the circumferential gap 670 by the first penetration distance (not labeled) and therefore causes the web to deflect into the circumferential gap 670 (e.g., in a direction towards the rotational axis 656 of the support arbor 650) such that the top surface of the web 1486 is in contact with the knife edge 858 and the bottom surface of the web 1486 is in contact with the first outer surface 666, part of the first edge 676, the second edge 678, and the second outer surface 668.

The contact by the knife edge 658, the sharp second edge 678, and a knife edge and a second edge of a neighboring support roller cause the web being held in tension between each knife edge. This tension may cause the web to be substantially immobilized with respect to motion relative to the knife cutter rollers and the plurality of support rollers in the plane of the web. FIG. 15 depicts another detail view of portions of one support roller and one cutter roller of FIG. 6 along with the web. Here, sections of two neighboring support rollers and knife cutter rollers identical to those depicted in FIG. 14 are seen along with the web 1486 that extends between these sections. As depicted, the penetration by knife edge 658A of knife cutter roller 646A of support roller 652A and by knife edge 658B of knife cutter roller 646B, along with the sharp second edge 678A of support roller 652A and the sharp second edge 678B of support roller 652B cause the web 1486 to be in tension between the two knife edges 658A and 658B. This tension in the web enables, at least in part, the web to be cut using a burst or rupture failure; this failure or rupture occurs at about the location of the knife edge 658 in the web 1486 because this is the location where the tensile strength of the web material is exceeded. In some embodiments, this failure mode has minimal shearing and in some such embodiments has no shearing. The material of the web also enables a burst failure because such web may be of a brittle material such that when it is fed through the cutting apparatus, the configuration of the cutting apparatus herein described causes the web to fracture and not shear. If the second edge 678 is not sharp enough, e.g., too rounded, then the web may not be held in the appropriate tension to cause the burst fracture. Other features of the apparatus may also increase the tension of the web, such as by increasing the coefficient of friction of the support rollers, e.g. by any conventional means, and/or by nipping of the web by elements of the cutting cylinder 640 and support cylinder 648, such as between a spacer roller 644 and a support roller 652.

Accordingly, referring back to FIG. 14, the deflection of and strain on the tensioned web in the circumferential gap 670 causes the web 1486 on the right side of the rupture site, e.g., which is about at the knife edge 658, to be plastically deformed and thus form the first down-burr 1414; the rounded first edge 678 causes the web 1486 on the left side of the rupture site, which again is about at the knife edge 658, to be elastically, or minimally plastically, deformed and therefore form second down-burr 1413. As noted above, the first down-burr 1414 may be angled away from the bottom surface of the web 1486, e.g., the surface of the web 1486 that contacts the support roller 652, by between about 90 degrees and about 150 degrees. The second down-burr 1413 may be angled away from the bottom surface of the web 1486 by between about 180 and about 160 degrees. Therefore, the existence of the rounded first edge enables the elastic deformation of the web at the fracture site while the sharp edge causes, among other things, the plastic deformation of the web at the fracture site. In other words, the web is both plastically and elastically (or minimally plastically deformed) in the cutting area, which may be the area of the circumferential gap. In this manner, each PV cell strip may be bounded by two different down-burrs on opposing parallel edges, like discussed above, e.g., with regard to FIG. 3.

The angles of the resulting down-burrs are affected by, among other things, the separation distance 684 of the knife edge 658 from the second side 674 of the support roller 652 (as seen in FIG. 13, for example) and/or the first radius 680 of the first edge 676 (as seen in FIG. 14, for instance). For example, in FIG. 14 the angle of the first down-burr 1414 may be decreased by decreasing the separation distance 684. The penetration distance 682 may also affect the resulting down-burr angles as well as the quality of the cut such that if the penetration distance is too low, for instance, then the burst cut may not occur. The shape of the knife edge may also affect the cut and angles of the resulting down-burrs. For example, if the knife edge is not a point load, or not substantially a point load, onto the web, then the burst fracture may not occur at the desired location or at all, and the shapes and/or angles of the down-burrs may not be desirable (the desirable angle being between about 90 degrees to about 150 degrees).

The various embodiments discussed herein are configured to produce PV cell strips of approximately the same width, and the spacing between neighboring knife cutter rollers 646, as well as neighboring support rollers 652, is correspondingly substantially uniform. However, some implementations may be configured to produce PV cell strips of differing widths from a single layered stack. This may be implemented by providing correspondingly different spacings between neighboring knife cutter rollers 646, as well as neighboring support rollers 652. It is to be understood that uniform spacing and non-uniform spacing of cutter rollers 646 and support rollers 652 is contemplated.

As noted above, the various components described herein may be single components, or may be composed of a plurality of components. For example, knife cutter rollers 646 may include a hardened steel outer race slipped over a less hard inner hub. It is to be understood that structures which provide the basic functionality of the structures described herein are contemplated as being within the scope of this disclosure as well.

The various rollers may be mounted to their respective arbors by any appropriate means, including but not limited to, bolting, friction mounting, etc. In certain implementations, the rollers may be connected to each other, e.g., by bolts.

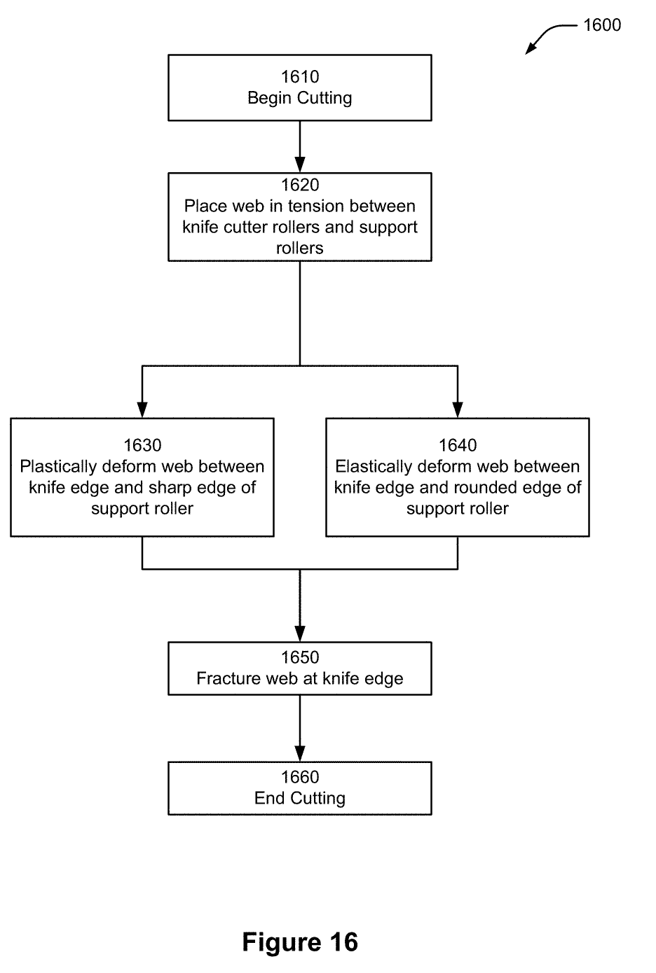

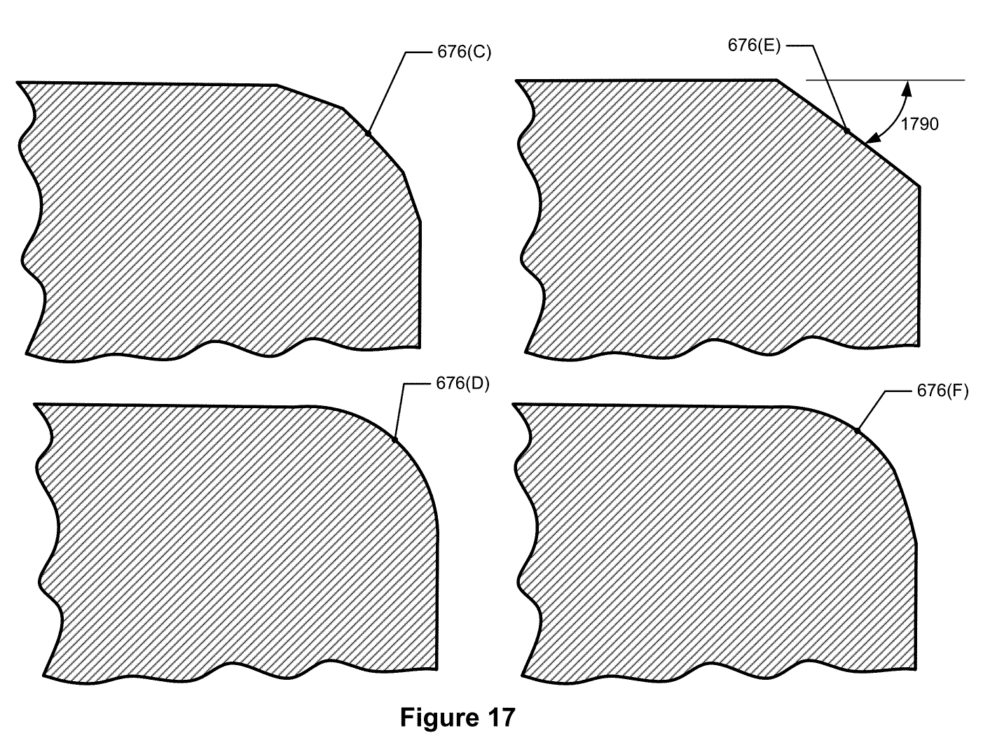

The above description of a cutting apparatus provides a framework for describing methods of cutting that may be employed with the present invention. The methods of cutting described further below are not, however, limited to the specific apparatuses described above. Methods of cutting the web using at least the example apparatus are also disclosed herein. For example, FIG. 16 depicts one example technique for cutting a PV stack web. In block 1610, the cutting process begins. In block 1620, portions of a PV stack web are placed in tension between a plurality of knife cutter rollers and a plurality of support rollers such that the PV web stack is substantially immobilized with respect to motion relative to each other in the plane of the PV stack web. This tension may be applied like discussed above, e.g., contact by at least the knife edges to the top of the web and the sharp second edges of the support rollers.

To cut the PV stack web, as described above, contact by the knife edge to the tensioned PV stack web is applied in a circumferential gap of the support roller, with the gap having a sharp edge and a rounded edge. The PV stack web between about the knife edge and the rounded edge of the circumferential gap is caused to elastically deform (or minimally plastically deform)(block 1640) while the PV stack between about the knife edge and the sharp edge of the circumferential gap is caused to plastically deform (block 1630). The point pressure by the knife edge exceeds the tensile strength of the PC stack web and causes the web to fail in a rupture or burst failure (block 1650). After the rupture or cutting (block 1660), the plastically deformed portion of the PV stack web remains deformed while the other portion that was elastically deformed elastically recovers such that it returns to 180 degrees or close thereto, such as between about 180 degrees and about 160 degrees.

What is claimed is:

1. An apparatus for cutting a web with a first face, a second face opposite the first face and offset from the first face by a nominal thickness, the apparatus comprising:
a plurality of substantially circular knife cutter rollers, each knife cutter roller having a substantially circular knife edge that is the outer-most circumferential boundary of the knife cutter roller;
a cutter arbor, wherein each knife cutter roller is coupled with the cutter arbor such that the knife edges are coaxial with each other;
a plurality of support rollers, each support roller having a substantially cylindrical first outer surface, a substantially cylindrical second outer surface coaxial with the first outer surface, and a circumferential gap between the first outer surface and the second outer surface, wherein each gap is partially defined by a first side, a second side that faces and is offset from the first side, a first edge where the first side intersects with the first outer surface, and a second edge where the second side intersects with the second outer surface, wherein the first edge is rounded with a first radius, and wherein the second edge is sharp or has a second radius that is substantially smaller than the first radius; and
a support arbor, wherein each support roller is coupled with the support arbor such that the support rollers are coaxial with each other, wherein:
the cutter arbor is offset from the support arbor, and the knife cutter rollers and the support rollers are axially spaced, such that one knife edge is positioned in the gap of each support roller and the web may be fed between the cutter arbor and the support arbor.

2. The apparatus of claim 1, wherein the second edge is sharp.

3. The apparatus of claim 1, wherein the second edge is rounded with the second radius that is substantially smaller than the first radius.

4. The apparatus of claim 1, wherein the knife edge is sharp.

5. The apparatus of claim 1, wherein the knife edge is rounded with a third radius that is substantially smaller than the first radius.

6. The apparatus of claim 1, wherein the knife edge is formed by the intersection of a first knife surface and a second knife surface and the internal angle between the first knife surface and the second knife surface is less than 180 degrees.

7. The apparatus of claim 6, wherein only the knife edge, at least a part of first knife surface, and at least a part of the second knife surface of each knife cutter roller are positioned in the gap.

8. The apparatus of claim 7, wherein neither the first knife surface nor the second knife surface are parallel to the support surfaces.

9. The apparatus of claim 6, wherein the knife edge is a type of edge selected from the group consisting of: V ground, convex, asymmetrical semi-convex, asymmetrical V, compound bevel, hollow ground, chisel, chisel back bevel, and chisel urasuki.

10. The apparatus of claim 1, wherein each knife edge is axially separated from each corresponding second face by a first separation distance and is positioned within the gap by a penetration distance such that it is closer to a rotational axis of the support arbor in a direction perpendicular to the rotational axis than the second outer surface of the support roller is to the rotational axis.

11. The apparatus of claim 1, wherein the apparatus is configured to cause a burst fracture of the web in each gap.

12. The apparatus of claim 11, wherein the apparatus is further configured to cause a first portion of the web closer to the first edge to elastically deform and a second portion of the web closer to the second edge to plastically deform.

13. The apparatus of claim 11, wherein the apparatus is configured not to cause shearing of the web.

14. The apparatus of claim 11, wherein:
the apparatus is further configured to separate the web into a plurality of strips,
each strip has a first strip face, a second strip face opposite the first strip face, a left side with a first down-burr, and a second side with a second down-burr,
the first down-burr is angled away from the second strip face by a first angle, and
the second down-burr is angled away from the second strip face by a second angle greater than the first angle.

15. The apparatus of claim 14, wherein the first angle is between about 90 degrees and about 150 degrees and the second angle is between about 160 degrees and about 180 degrees.

16. The apparatus of claim 1, wherein the apparatus is configured to cause a web that is fed between the cutter arbor and the support arbor to have the first face in contact with each knife edge and the second face in contact with each first outer surface, second outer surface, and second edge.

17. The apparatus of claim 1, wherein the only part of the cutter arbor in contact with the first face of the web is the knife edge of each cutter roller.

18. The apparatus of claim 1, wherein the apparatus is further configured to hold the web in tension by causing at least two neighboring knife edges to contact the first face of the web and simultaneously causing the second edge that is axially between the two neighboring knife edges to contact the second face of the web.

19. An apparatus for cutting a web with a first face, a second face opposite the first face and offset from the first face by a nominal thickness, the apparatus comprising:
a plurality of substantially circular knife cutter rollers, each knife cutter roller having a substantially circular knife edge that is the outer-most circumferential boundary of the knife cutter roller;
a cutter arbor, wherein each knife cutter roller is coupled with the cutter arbor such that the knife edges are coaxial with each other;
a plurality of support rollers, each support roller having a substantially cylindrical first outer surface, a substantially cylindrical second outer surface coaxial with the first outer surface, and a circumferential gap between the first outer surface and the second outer surface, wherein each gap is partially defined by a first side, a second side that faces and is offset from the first side, a first edge where the first side intersects with the first outer surface, and a second edge where the second side intersects with the second outer surface, wherein the first edge is of a geometry that includes one or more of: two or more facets, a chamfer, and a combination of two or more facets, a chamfer, and one or more curved surfaces, and wherein the second edge is sharp or has a second radius that is substantially smaller than the vertical depth of the first edge in a direction perpendicular to a rotational axis of a support arbor; and
the support arbor, wherein each support roller is coupled with the support arbor such that the support rollers are coaxial with each other, wherein:
the cutter arbor is offset from the support arbor, and the knife cutter rollers and the support rollers are axially spaced, such that one knife edge is positioned in the gap of each support roller and the web may be fed between the cutter arbor and the support arbor.

20. The apparatus of claim 19, wherein the second edge is sharp.
